(19) United States
(12) Patent Application Publication
(10) Pub. No.: US 2020/0142461 A1
(43) Pub. Date: May 7, 2020

(54) INTEGRATED CIRCUIT WITH CHIP-LEVEL SERIAL POWER DOMAINS, AND CIRCUIT BOARD HAVING THE SAME

(71) Applicant: BITMAIN INC., San Jose, CA (US)

(72) Inventor: Peter Douglas HOLM, Seattle, WA (US)

(21) Appl. No.: 16/670,811

(22) Filed: Oct. 31, 2019

Related U.S. Application Data
(60) Provisional application No. 62/753,638, filed on Oct. 31, 2018.

(51) Int. Cl. G06F 1/26; G06Q 20/06

(52) U.S. Cl. CPC G06F 1/26; G06Q 20/065

(57) ABSTRACT

A multi-core processing integrated circuit (IC) chip includes a plurality of processing unit groups. Each processing unit group includes a group voltage input terminal, a group voltage ground terminal, and one or more processing units, each processing unit having a voltage input terminal and a voltage ground terminal. The plurality of processing unit groups includes a bottom-level processing unit group and a top-level processing unit group. The group voltage ground terminal of the bottom-level processing unit group is connected to a ground pin of the multi-core processing integrated circuit chip. For each processing unit group other than the bottom-level processing unit group, the group voltage ground terminal of the processing unit group is connected to the group voltage input terminal of a previous-level processing unit group within the plurality of processing unit groups. The group voltage input terminal of the top-level processing unit group is connected to a voltage power input pin of the multi-core processing integrated circuit chip.

### CROSS-REFERENCE TO RELATED APPLICATION

This application claims the priority of U. S. Provisional Patent Application No. 62,753,638, titled “SYSTEMS AND METHODS FOR CHIPS INCLUDING SERIAL VOLTAGE DOMAINS”, filed on Oct. 31, 2018, the entire contents of which are incorporated herein by reference.

### TECHNICAL FIELD

The present disclosure relates to the technical field of power integrity for integrated circuits (ICs), in particular to chip-level serial power domains.

### BACKGROUND

With the rapid development in large-scale computing, as well as global awareness of environmental protection and energy conservation, energy efficiency has become an important aspect in the design and development of hardware computing systems. At present, many computing systems based on large-scale integrated circuits (ICs) adopt a parallel power-supply architecture, in which all IC chips on a circuit board share a same voltage input connection for a positive voltage supply and a same ground connection for voltage ground. A regulator is typically used to convert a high supply voltage to a low working voltage of the IC chips. The power efficiency of the regulator may be significantly impacted by a large down-conversion ratio between the high supply voltage and the low working voltage. Further, multiple processing cores (or units) within an IC chip also use a parallel power-supply architecture, which requires a large total current that results in a significant IR voltage drop due to packaging resistance. As a result, system-level power efficiency of the computing systems may be significant reduced. In order to improve conversion efficiency of the power supply, certain systems adopt a board-level serial power domain architecture, in which two or more IC chips are connected in series on a circuit board, and multi-stage series voltage domains are formed between the power input end and the ground end of the circuit board. Although the board-level series power supply architecture may effectively improve power conversion efficiency of the regulator, it still suffers certain drawbacks such as the packaging IR drop and difficulties to match power consumption of each IC chip connected in series.

The embodiments of the present disclosure address the limitations of existing power supply architectures for IC chips.

### SUMMARY

In one aspect of the present disclosure, a multi-core processing integrated circuit (IC) chip having a series power supply is provided. The IC chip includes a plurality of processing unit groups, each processing unit group including a group voltage input terminal, a group voltage ground terminal, and one or more processing units. Each processing unit has a voltage input terminal and a voltage ground terminal. The plurality of processing unit groups includes a bottom-level processing unit group and a top-level processing unit group. The group voltage ground terminal of the bottom-level processing unit group is connected to a ground pin of the multi-core processing integrated circuit chip. For each processing unit group other than the bottom-level processing unit group, the group voltage ground terminal of the processing unit group is connected to the group voltage input terminal of a previous-level processing unit group within the plurality of processing unit groups. The group voltage input terminal of the top-level processing unit group is connected to a voltage power input pin of the multi-core processing integrated circuit chip.

In certain embodiments, a voltage drop between the group voltage input terminal and the group voltage ground terminal is identical for each of the plurality of processing unit groups.

In certain embodiments, the processing units within the plurality of processing unit groups are all identical to each other, and each processing unit group includes a same number of processing units.

In certain embodiments, for at least one of the plurality of processing unit groups, the processing unit group includes a plurality of processing units.

In certain embodiments, for the plurality of processing units within the processing unit group, the voltage input terminals of the processing units are connected together to form the group voltage input terminal of the processing unit group, and the voltage ground terminals of the processing units are connected together to form the group voltage ground terminal of the processing unit group.

In certain embodiments, the IC chip includes a plurality of deep n-wells corresponding to the plurality of processing unit groups, each processing unit group being located at the corresponding deep n-well.

In certain embodiments, a p-well is configured within each deep n-well to form a plurality of NMOS transistors.

In certain embodiments, a second n-well is configured within each p-well to form a plurality of PMOS transistors.

In certain embodiments, a number of the plurality of processing unit groups is no less than 3.

In another aspect of the present disclosure, a circuit board is provided. The circuit board comprises a multi-core processing integrated circuit chip, the multi-core processing integrated circuit chip including: a plurality of processing unit groups, each processing unit group including a group voltage input terminal, a group voltage ground terminal, and one or more processing units, each processing unit having a voltage input terminal and a voltage ground terminal; wherein: the plurality of processing unit groups includes a bottom-level processing unit group and a top-level processing unit group; the group voltage ground terminal of the bottom-level processing unit group is connected to a ground pin of the multi-core processing integrated circuit chip; for each processing unit group other than the bottom-level processing unit group, the group voltage ground terminal of the processing unit group is connected to the group voltage input terminal of a previous-level processing unit group within the plurality of processing unit groups; and the group voltage input terminal of the top-level processing unit group is connected to a voltage power input pin of the multi-core processing integrated circuit chip.

The above aspects will be described in the detailed description and accompanying drawings.

### BRIEF DESCRIPTION OF THE DRAWINGS

In order to more clearly illustrate the technical solutions in the embodiments of the present disclosure, the drawings used in the description of the embodiments will be briefly described below. It is obvious that the drawings in the following description are only some embodiments of the present disclosure. Other drawings may be obtained by those of ordinary skill in the art based on these drawings.

FIG. 1 is a diagram showing an IC chip according to some embodiments;

FIG. 2 is a diagram showing an IC chip according to some embodiments;

FIG. 3A is a diagram showing an IC chip according to some embodiments;

FIG. 3B is a diagram showing an IC chip according to some embodiments;

FIG. 4A is a diagram showing an IC chip according to some embodiments;

FIG. 4B is a diagram showing a die-based implementation of a plurality of serial voltage domains of an IC chip according to some embodiments;

FIG. 4C is a diagram showing a die-based implementation of the one or more serial voltage domains of an IC chip according to some embodiments; and

FIG. 5 is a diagram showing a circuit board according to some embodiments.

### DETAILED DESCRIPTION

Exemplary embodiments will be described in detail herein. These embodiments are illustrated in the accompanying drawings. In the following description, unless otherwise indicated, same or similar referral numerals may refer to the same or similar elements in different drawings. The implementation manners described in the following exemplary embodiments do not represent all embodiments of the present disclosure. Instead, they are merely examples of devices and methods consistent with aspects provided by the present disclosure as detailed in the claims.

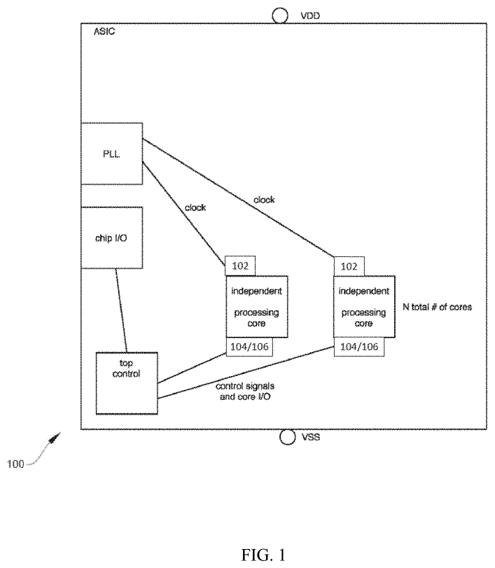

FIG. 1 is a diagram showing an IC chip 100 according to some embodiments. In certain embodiments, the IC chip 100 may be an application-specific integrated circuit (ASIC) chip customized for a particular use, such as being adapted for performing cryptocurrency mining computations. The IC chip 100 may include an input/output component (e.g., chip I/O), a phase-locked loop (PLL) component, a top control component, one or more independent processing cores, and two voltage terminals (e.g., VDD terminal and VSS terminal). In certain embodiments, the PLL component may be configured to generate one or more clock signals. In certain embodiments, the PLL component may include a 24 MHz quartz clock. In certain embodiments, the PLL component may further be configured to send the generated one or more clock signals to the one or more independent processing cores.

An independent processing core may read and execute program instructions independently. An independent processing core may also be termed as a processing unit. In the present disclosure, the terms “independent processing core”, “processing core”, and “processing unit” may be used interchangeably. In certain embodiments, the IC chip 100 may have a plurality of processing cores (or processing units). That is, IC chip 100 may be a multi-core processor. The total number of independent processing cores of the chip 100 may be N.

In some embodiments, each independent processing core may be configured to receive, at a terminal 102, at least one of the one or more clock signals from the PLL component. In certain embodiments, each independent processing core may be further configured to receive, at terminal 104, signals from the top control component. In certain other embodiments, each independent processing core may be further configured to receive, at terminal 104, signals from another independent processing core. The received signals may include data signals, control signals and/or core input/output (I/O) signals. In certain embodiments, each independent processing core may be further configured to send, from terminal 106, signals to the top control component. In certain embodiments, the sent signals may include data signals, control signals and/or core I/O signals.

In certain embodiments, the top control component may be configured to receive signals from and/or send signals to each independent processing core. For examples, the received signals and/or sent signals may include data signals, control signals and/or core I/O signals. In certain embodiments, the top control component may further be configured to receive signals from and/or send signals to the input/output component. In certain embodiments, the received signals and/or sent signals may include data signals.

According to some embodiments, the input/output component may be configured to receive signals from and/or send signals to the top control component. In certain embodiments, the received signals and/or sent signals may include data signals. In certain embodiments, the input/output component may be connected to one or more input terminals of the IC chip 100. In certain embodiments, the one or more input terminals may be configured to receive external data signals. In certain other embodiments, the input/output component may be connected to one or more output terminals of the IC chip 100. In certain embodiments, the one or more output terminals are configured to output processed data signals from the IC chip 100.

According to certain embodiments, each of the two voltage input terminals (e.g., a VDD terminal and a VSS terminal) of the IC chip 100 may be configured to receive an external signal. In certain embodiments, the received external signal may provide power to one or more components of the IC chip 100.

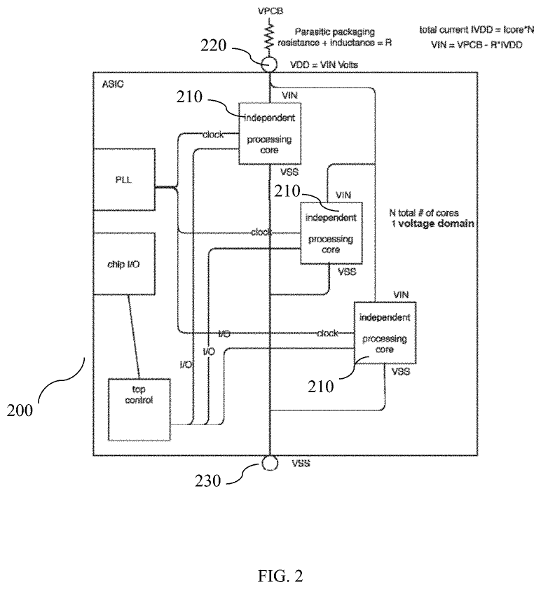

FIG. 2 is a diagram showing an IC chip 200 (e.g., an ASIC chip) according to some embodiments. In certain embodiments, the IC chip 200 may include an input/output component (e.g., chip I/O), a phase-locked loop (PLL) component, a top control component, one or more independent processing cores 210, and two chip voltage terminals (e.g., a chip VDD terminal 220 and a chip VSS terminal 230). In certain embodiments, the PLL component may be configured to generate one or more clock signals. The PLL component may be further configured to send the generated one or more clock signal to the one or more independent processing cores. In certain embodiments, the IC chip 200 may have a plurality of processing cores 210. That is, IC chip 200 may be a multi-core processor. The total number of independent processing cores of the chip 100 may be N.

In some embodiments, the IC chip 200 may include a single voltage domain. In certain embodiments, the single voltage domain may include all of the independent processing cores of the chip 200. That is, all of the independent processing cores (or units) of the chip 200 form a single processing unit group.

The plurality of independent processing cores may be connected in parallel with respect to the two chip voltage terminals (e.g., the VDD chip terminal 220 and the VSS chip terminal 230) of the IC chip 200. In certain embodiments, each independent processing core may include two core voltage terminals (e.g., a VIN core terminal and a VSS core terminal). In certain embodiments, each of the two chip voltage terminals (e.g., VDD terminal 210 and VSS terminal 230) may be configured to receive an external signal. In certain embodiments, the received external signal provides power to one or more component of the IC chip 200. In certain embodiments, the VDD terminal of the chip 200 may be at a voltage of V_{IN} volts, the VSS terminal of the chip 200 may be at a voltage of V_{SS} volts, the VIN terminal of each independent processing core may be at a voltage of V_{IN} volts, and the VSS terminal of each independent processing core may be at a voltage of V_{SS} volts.

In certain embodiments, one of the two core voltage terminals (e.g., the VIN terminal) of each independent processing core may be connected to the one of the chip voltage terminals (e.g., VDD terminal) of the chip 200. In certain embodiments, the other of the two core voltage terminals (e.g., VSS terminal) of each independent processing core may be connected to the other voltage chip terminal (e.g., VSS terminal) of the chip 200.

According to some embodiments, each independent processing core may be configured to receive at least one clock signal of the one or more clock signals from the PLL component. In certain embodiments, each independent processing core may be further configured to receive signals from the top control component. In certain embodiments, the received signals include data signals, control signals and/or core input/output signals. In certain embodiments, each independent processing core may be further configured to send signals to the top control component. In certain embodiments, the sent signals may include data signals, control signals and/or core input/output signals.

According to certain embodiments, the top control component may be configured to receive signals from and/or send signals to each independent processing core. For examples, the received signals and/or sent signals include data signals, control signals and/or core input/output (I/O) signals. In certain embodiments, the top control component may be further configured to receive signals from and/or send signals to the input/output component. In certain embodiments, the received signals and/or sent signals include data signals.

In some embodiments, the input/output component may be configured to receive signals from and/or send signals to the top control component. In certain embodiments, the received signals and/or sent signals include data signals. In certain embodiments, the input/output component may be connected to one or more input terminals of the IC chip 200. In certain embodiments, the one or more input terminals are configured to receive external data signals. In certain other embodiments, the input/output component may be connected to one or more output terminals of the IC chip 200. In certain embodiments, the one or more output terminals may be configured to output processed data signals from the IC chip 200.

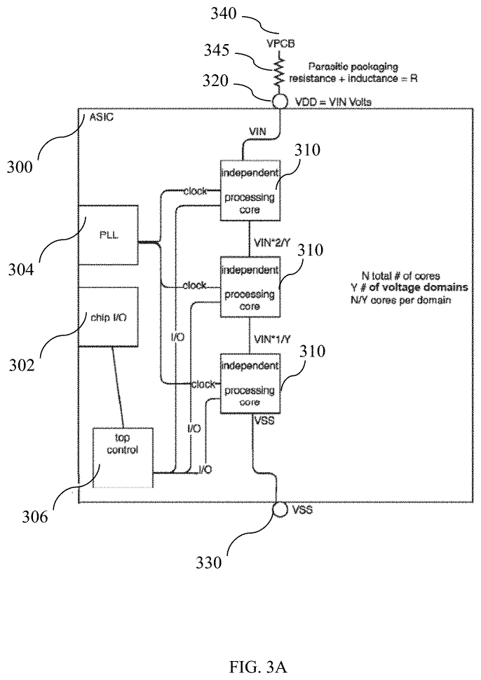

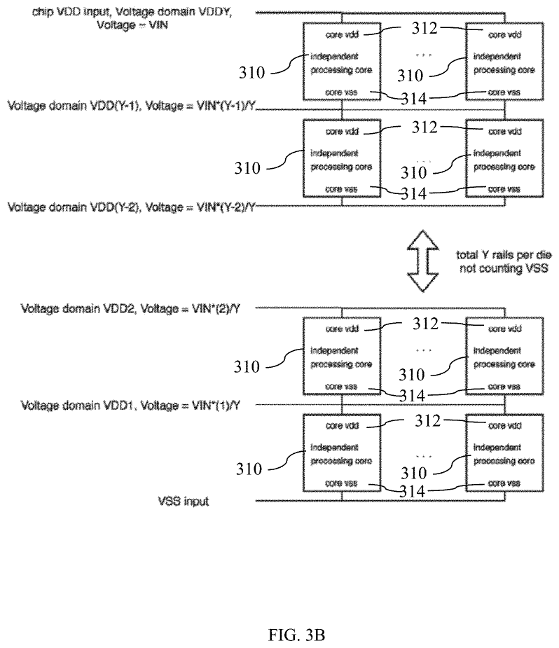

FIG. 3A is a diagram showing an IC chip 300 (e.g., ASIC chip) according to some embodiments. In certain embodiments, the chip 300 may include an input/output component (e.g., chip I/O) 302, a phase-locked loop (PLL) component 304, a top control component 306, one or more independent processing cores 310, and two chip voltage terminals 320 and 330 (e.g., a VDD terminal and a VSS terminal). In certain embodiments, the PLL component 304 may be configured to generate one or more clock signals. The PLL component 304 may be further configured to send the generated one or more clock signals to the one or more independent processing cores 310. The independent processing cores 310 may read and execute program instructions independently. In certain embodiments, the IC chip 300 may have a plurality of independent processing cores (or processing units) 310. That is, the IC chip 300 may be a multi-core processor. The total number of the independent processing cores may be N, where N is a positive integer greater than 1.

In some embodiments, the IC chip 300 may include one or more voltage domains. In certain embodiments, each voltage domain may include one or more independent processing cores 310 of the IC chip 300. In other words, the independent processing cores (or processing units) 310 of the IC chip 300 are divided into one or more processing unit groups. In the present disclosure, the terms “voltage domain” and “processing unit group” may be used interchangeably. In certain embodiments, the one or more cores 310 of one voltage domain (e.g., one voltage rail) may be connected in series with respect to the one or more cores 310 of any other voltage domain (e.g., other voltage rail). As an example, the one or more cores 310 of the same voltage domain (e.g., same voltage rail) may be connected in parallel to any other core 310 of the same voltage domain (e.g., same voltage rail). In certain embodiments, the number of voltage domains of the chip 300 may be Y. In certain embodiments, the N number of independent processing cores 310 may be equally distributed across the Y number of voltage domains. That is, the number of independent processing cores per voltage domain (e.g., per voltage rail) of the chip 300 may be N/Y. In certain other embodiments, the plurality of the independent processing cores are not equally distributed across the across the Y number of voltage domains. In certain other embodiments, the plurality of the independent processing cores may be identical to each other in structure or functions. For example, the plurality of the independent processing cores may operate at different clock frequencies. In certain embodiments, a voltage drop of each voltage domain is identical to the voltage drop of other voltage domains on the IC chip. That is, even though each voltage domain may not have the same structure of functions, a input voltage is evenly distributed among the plurality of voltage domains when they are connected in series.

In certain embodiments, each of the two chip voltage terminals (e.g., VDD terminal and VSS terminal) of the chip 300 may be configured to receive an external signal. In certain embodiments, the received external signal may provide power to one or more components of the IC chip 300. In certain embodiments, the VDD terminal of the chip 300 may be provided a voltage of V_{IN} volts. The VSS terminal of the chip 300 may be provided a voltage of V_{SS} volts. In certain embodiments, the VSS terminal of the chip 300 may be at a zero voltage, that is, the VSS terminal is a GND terminal.

In certain embodiments, the voltage drop across each voltage domain (e.g., each voltage rail) equals a voltage difference across the IC chip divided by the number voltage domains. In certain embodiments, the voltage difference across the IC chip equals the voltage at the VDD terminal of the chip 300 minus the voltage at the VSS terminal of the chip 300. That is, voltage drop across each voltage domain V_{D}=(V_{DD}−V_{SS})/Y. In certain embodiments, the voltage at the VDD terminal of the chip 300 is V_{IN} volts and the voltage at the VSS terminal of the chip is zero voltage. That is, the VSS terminal 330 of the chip 300 is connected to a voltage ground. Accordingly, the voltage drop across each voltage domain (e.g., each voltage rail) of the chip 300 equals V_{IN}/Y. In certain embodiments, the voltage drop across all voltage domains (e.g., all voltage rails) of the chip 300 equals V_{IN} Volts. In certain embodiments, the voltage drop across two voltage domains (e.g., two voltage rails) equals 2 V_{IN}/Y.

In certain embodiments, the VDD terminal 320 may be connected to a voltage terminal 340 (e.g., VPCB) of the of the printed circuit board (PCB) via a resistance component 345 (e.g., R). In certain embodiments, the resistance component 345 may include parasitic packaging of the PCB. In certain embodiments, the resistance component 345 may include inductance of the PCB. In certain embodiments, the voltage at the VDD terminal of the chip 300 may be equal to the PCB voltage V_{PCB} minus the product of the resistance of the resistance component 345 and a total current (e.g., I_{VDD}) flowing through the VDD terminal of the chip 300. That is, V_{DD}=V_{PCB}−RI_{VDD}. In certain embodiments, the total current (e.g., I_{VDD}) flowing through the VDD terminal of the chip 300 equals the number of independent processing cores per voltage domain (e.g., N/Y) times the current flowing through each processing core. That is,

$${I}_{VDD} = ( \frac{N}{Y} ) {I}_{CORE} .$$

According to certain embodiments, each independent processing core 310 may be configured to receive at least one clock signal of the one or more clock signal from the PLL component 304. In certain embodiments, each independent processing core 310 may be further configured to receive signals from the top control component 306. The received signals may include data signals, control signals and/or core input/output signals. In certain embodiments, each independent processing core 310 may be further configured to send signals to the top control component 306. The sent signals may include data signals, control signals and/or core input/output signals.

According to certain embodiments, the top control component 306 may be configured to receive signals from and/or send signals to each independent processing core 310. For examples, the received signals and/or sent signals may include data signals, control signals and/or core input/output (I/O) signals. In certain embodiments, the top control component 306 may be further configured to receive signals from and/or send signals to the input/output component 302. The received signals and/or sent signals include data signals.

In some embodiments, the input/output component 302 may be to receive signals from and/or send signals to the top control component 306. The received signals and/or sent signals may include data signals. In certain embodiments, the input/output component 302 may be connected to one or more input terminals of the IC chip 300. In certain embodiments, the one or more input terminals of IC chip 300 may be configured to receive external data signals. In certain other embodiments, the input/output component 302 may be connected to one or more output terminals of the IC chip 300. The one or more output terminals may be configured to output processed data signals from the IC chip 300.

FIG. 3B is a diagram showing the IC chip 300 (e.g., an ASIC chip) according to some embodiments. In certain embodiments, the IC chip 300 may include one or more voltage domains (e.g., voltage rails) connected in series. Each voltage domain includes one or more independent processing cores 310. In other words, the independent processing cores (or processing units) 310 of the IC chip 300 are divided into one or more processing unit groups. In certain embodiments, the chip 300 may include Y number of rails per die. As an example, the one or more voltage domains (e.g., voltage rails) include voltage domain VDD1, VDD2, . . . , VDD(Y−1), and VDDY. In certain embodiments, each voltage domain (e.g., voltage rail) may include one or more independent processing cores 310. In certain embodiments, the total number of independent processing cores of the chip 300 equals N. In certain embodiments, the N number of independent processing cores may be equally distributed in the Y number of voltage domains. Accordingly, the number of independent processing cores per voltage domain (e.g., per voltage rail) equals N/Y. In certain embodiments, each independent processing core 310 may include a core VDD terminal 312 and a core VSS terminal 314. In certain other embodiments, each independent processing core 310 are identical to each other. In some example, each independent processing core 310 draws a same current as the other one or more independent processing cores 310.

In certain embodiments, the voltage drop across each voltage domain (e.g., each voltage rail) may be equal to a voltage difference across the IC chip divided by the number of voltage domains. In certain embodiments, the voltage difference across the IC chip may be equal to the voltage at the VDD terminal of the chip 300 minus the voltage at the VSS terminal of the chip 100. That is, V_{D}=(V_{DD}−V_{SS})/Y. In certain embodiments, the voltage at the VDD terminal of the chip 300 is V_{IN} volts and the voltage at the VSS terminal of the chip is zero voltage. That is, the VSS terminal 330 of the chip 300 is connected to a voltage ground. Accordingly, the voltage drop across each voltage domain (e.g., each voltage rail) of the chip 300 equals V_{IN}/Y. In certain embodiments, the voltage drop across all voltage domains (e.g., all voltage rails) of the chip 300 equals V_{IN}. In certain embodiments, the voltage drop across two voltage domains (e.g., two voltage rails) equals 2 V_{IN}/Y. In certain embodiments, the IC chip 300 may include two voltage domains. That is, Y=2. If V_{IN}=1V, the voltage drop across each of the two domains equals 0.5V.

Referring to FIG. 2, in certain embodiments, the IC chip 200 may include N number of independent processing cores (e.g., 100 cores) in parallel. The total current I_{VDD} flowing through the chip 200 equals NI_{CORE}, (e.g., 100I_{CORE}) where 1_{CORE} represents the current flowing through each independent processing core. Referring to FIG. 3B, in certain embodiments, the chip 300 may include N number of independent processing cores (e.g., 100 cores) in Y serial voltage domains (e.g., 10 serial voltage domains). In certain embodiments, the N number of independent processing cores are equally distributed in Y number of serial voltage domains. Accordingly, each of the Y number of serial voltage domains includes N/Y number of independent processing cores per serial voltage domain (e.g., 10 cores/domain). The total current I_{VDD} flowing through the chip 300 may be equal to the number of independent processing cores per voltage domain (e.g., 10) times the current flowing through each independent processing core. That is,

$${I}_{VDD} = ( \frac{N}{Y} ) {I}_{CORE}$$

(e. g., I_{VDD}=10I_{CORE}) where I_{CORE} represents the current flowing through each independent processing core in parallel included in the voltage domains. The ratio of the total current drawn by the Y-serial voltage domain chip (e.g., 10-serial voltage domain chip) compared to the total current drawn by the parallel voltage domain chip may be equal to 1/Y (e.g., 1/10). The voltage drop across each of the Y serial voltage domain is proportional to 1/Y, and the total reduction in packaging IR drop from the parallel domain chip to the Y-serial voltage domain chip (e.g., 10-serial voltage domain chip) is proportional to Y·Y=Y² (e.g., 10·10=100).

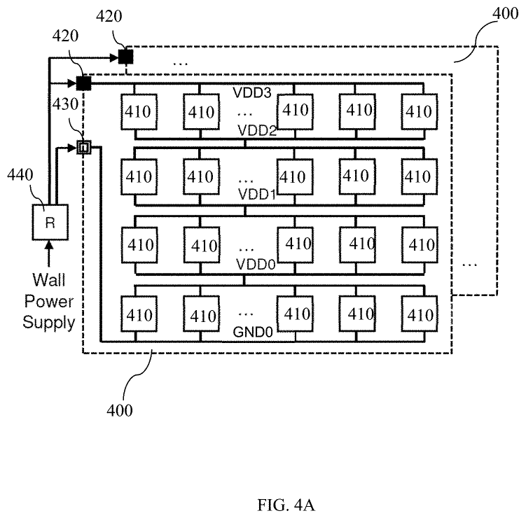

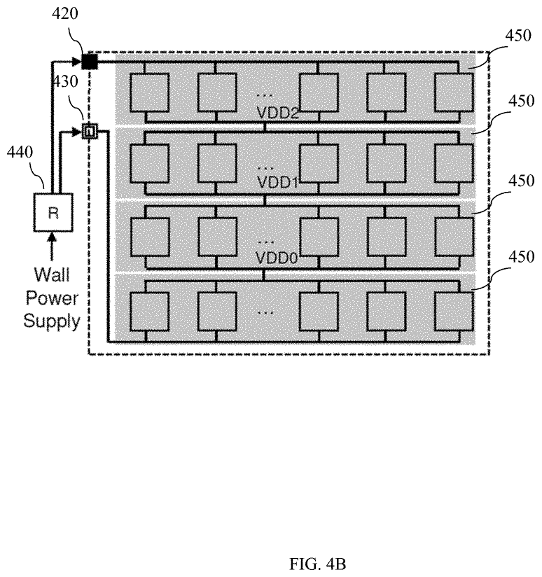

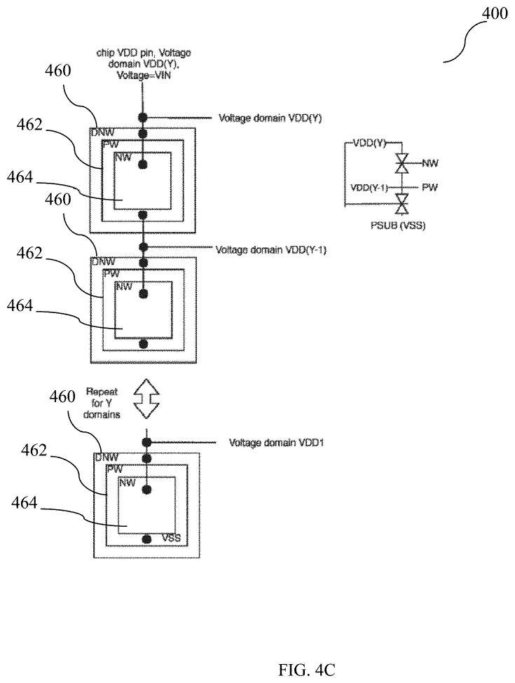

FIG. 4A is a diagram showing a circuit for a plurality of IC chips 400 (e.g., an ASIC chip) according to some embodiments. In certain embodiments, each IC chip 400 may include a plurality of voltage domains (e.g., voltage rails). Each voltage domain (e.g., voltage rail) may include one or more independent processing cores 410. In other words, the independent processing cores (or processing units) 410 of the IC chip 400 are divided into a plurality of processing unit groups. For each IC chip 400, the plurality of voltage domains (or processing unit groups) may be connected in series. The independent processing cores 410 within each voltage domain may be connected in parallel. Specifically, as shown in FIG. 4A, the independent processing cores 410 in the voltage domain shown in each row are connected in parallel. And the multiple voltage domains shown in the multiple rows are connected to each other in series. That is, in each voltage domain, the voltage input terminals (VDDs) of all independent processing cores 410 in the voltage domain are connected to each other, and the ground terminals (GNDs) of all independent processing cores 410 in the voltage domain are connected to each other. Further, the voltage input terminals (VDDs) of all independent processing cores 410 in a voltage domain are connected to the ground terminals (GNDs) of the independent processing cores 410 in a next voltage domain. Thus, the voltage inputs (VDDs) of the multiple voltage domains are stacked, e. g., resulting in the stacked voltage inputs VDD0, VDD1, VDD2, and VDD3 as shown in FIG. 4A. The top voltage input (e. g., VDD3 in FIG. 4A) may be connected to a chip VDD pin 420. The bottom terminal (e. g. GND0 in FIG. 4A) may be connected to a chip GND pin 430. The chip VDD pin 420 and chip GND pin 430 may be connected to a voltage output port of a regulator 440 which converts a standard power supply voltage to a suitable voltage output.

In certain embodiments, for each IC chip 400, the plurality of independent processing cores 410 may be evenly distributed in the plurality of voltage domains. Further, the plurality of independent processing core 410 may be identical to each other or take identical power. Thus, the voltage output from the regulator may be evenly distributed across the plurality of voltage domains. In the example shown in FIG. 4A, there are 4 voltage domains on the IC chip 400. If the chip voltage input (V_{DD}_chip is 1.6V, then the voltage difference across each voltage domain is (V_{DD})_{chip}/4=0.4V. For example, for the first (bottom) voltage domain, the VDD0 input is at a 0.4V voltage and the GND0 input is at 0V voltage. For the next (second) voltage domain, the VDD1 input is at a 0.8V and the GND input is at 0.4V. For the next (third) voltage domain, the VDD2 input is at 1.2V and the GND2 input is at 0.8V. For the next (fourth and top) voltage domain, the VDD3 input is at 1.6V and the GND2 input is at 1.2V. Thus, without requiring to change the voltage drop across each processing core, the circuit shown in FIG. 4A may effectively reduce the down conversion requirement of the regular 440 (e. g., converting voltage to 1.6V instead of 0.4V), thus improving power conversion efficiency.

Further, the series connection of the multiple voltage domains may effectively reduce total current of the IC chip 400, and thus reducing power loss due to IR drop, R including the chip packaging resistance and inductance (as shown in FIG. 3A). For example, if an IC chip 400 requires a 5 W power input, each independent processing core 410 has an input voltage difference of 0.4V, and the plurality of independent processing cores 410 are distributed into 4 voltage domains, the total current I_{VDD} of the chip may be calculated as I_{VDD}=5 W/(0.4V×4)=3.125A. Supposing there is a package resistance R=0.001Ω at the chip VDD pin 420 and chip GND pin 430, the IR drop due to the package resistance is V_{IR}=3.125A×0.001Ω=3.125 mV. The IR drop may be considered to be evenly split across the 4 voltage domains. Thus, the equivalent voltage drop for each voltage domain may be considered as 1/16 of the voltage drop without adopting the serial voltage domain configuration, which is significantly reduced.

Further as shown in FIG. 4A, the multiple IC chips 400 may be connected in parallel to each other. That is, the chip VDD pin 420 and chip GND pin 430 of each IC chip 400 may be connected to the voltage output port of the regulator 440. Thus, each IC chip 400 receive a same voltage input from the regulator 440 without requiring the plurality of IC chips 400 being identical. This offers design flexibility of the circuit board.

Although FIG. 4A illustrates an IC chip 400 having 4 voltage domains (or processing unit groups). The number of voltage domains within an IC chip is not limited in the present disclosure. For example, the IC chip 400 may have 1, 2, 3, 4, . . . 10, or more voltage domains (or processing unit groups). The number of independent processing cores within a voltage domain is also not limited in the present disclosure. These numbers may be chosen according to a specific application and design.

In certain embodiments, the plurality of independent processing cores (or processing units) on the IC chip may be identical to each other. In certain embodiments, there may be a slight variance in the properties of the processing units due to variation in manufacturing conditions. In certain embodiments, as shown in FIG. 3A, the IC chip 300 may further include a top control component 306. The top control component 306 may adjust the circuit to the variances in the independent processing cores 310 and balance the plurality of power domains. Further, the IC chip 300 may include a level shifter component to convert signal voltage levels to and from the voltage domains.

FIG. 4B illustrates a die-based implementation of a plurality of serial voltage domains (e.g., voltage rails) of the IC chip 400 (e.g., ASIC chip) according to some embodiments. For certain embodiments, the IC chip 400 may include a plurality of voltage domains. Within each voltage domain, the body terminals of all transistors may be connected to the silicon substrate through a GND terminal. If the substrate is shared across multiple domains, the top voltage domains may be connected to a high potential. Thus, the substrate may need to be isolated into different domains as well. In certain embodiments, a plurality of deep N-wells may be used to isolate the different voltage domains. As shown in FIG. 4B, each voltage domain may correspond to a deep N-well 450 (shown in the shaded areas) on the substrate.

FIG. 4C illustrates a die-based implementation of the one or more serial voltage domains (e.g., voltage rails) of an IC chip 400 (e.g., ASIC chip) according to some embodiments. In certain embodiments, the die-based implementation may include a p-substrate (PSUB). As an example, the p-substrate may be at a voltage that is equal to a VSS voltage of the chip 400. In certain embodiments, the IC chip 400 may include a plurality of deep n-wells (DNWs) 460. Each DNW 460 may correspond to one of the serial voltage domains. In certain embodiments, a p-well (PW) 462 may be configured within each deep DNW 460. NMOS transistors may be fabricated on the DNW-PW structure. In certain embodiments, a second n-well (NW) 464 may be configured within each p-well 462. PMOS transistors may be fabricated on the PW-NW structure. In certain embodiments, each DNW 460 may be tied to the lowest voltage of the associated die block.

In certain embodiments, the forgoing IC chip may be used to perform digital calculations in a cryptocurrency mining process. In one example, BitCoin uses the SHA-256 hash algorithm to generate verifiably “random” numbers in a way that requires a predictable amount of CPU effort. Generating a SHA-256 hash with a value less than the current target solves a block and wins coins for mining machines. When a SHA-256 algorithm is used to solve a hash for block in a blockchain, the mining computer may calculate a hash functions of a set of random numbers to find a combination that match the current condition for a new block. As a result, an extremely large amount of computation may be required. The computational IC chip in the foregoing description may be used as Application Specific Integrated Chips (ASIC) to perform multiple hash calculations in parallel using the multiple independent processing cores. These ASICs may be used to calculate a single hash or an iterated hash in parallel. Embodiments of the present disclosure provide a technical solution for improving power efficiency of large-scale computation systems while allowing flexibility in circuit design and arrangement.

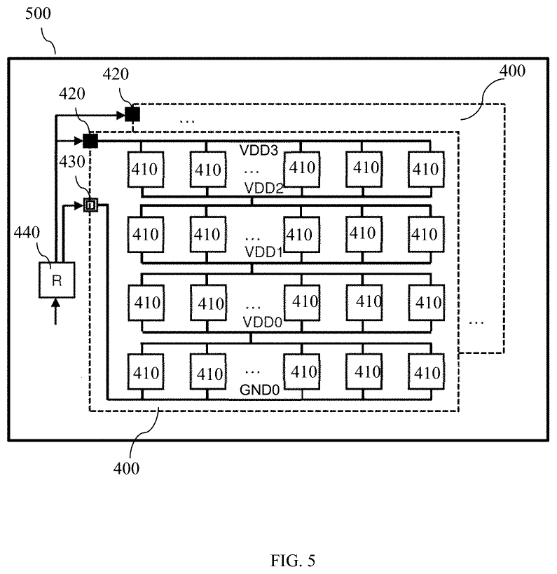

According to another aspect of the present disclosure, a circuit board is provided. In certain embodiments, as shown in FIG. 5, the circuit board 500 may include one or more IC chips 400 as disclosed in the foregoing description. The details of the IC chips 400 are not repeated herein. In certain embodiments, the power supply of the plurality of IC chips 400 may be connected in parallel.

The forgoing description and embodiments are exemplary descriptions of the technical solutions provided by the present disclosure. Other embodiments of the disclosure will be apparent to those skilled in the art. The present disclosure is intended to cover any variations, modifications, equivalent substitutions, uses, or adaptations that are in accordance with the general principles of the present disclosure.

What is claimed is:

1. A multi-core processing integrated circuit chip having a series power supply, comprising:
a plurality of processing unit groups, each processing unit group including a group voltage input terminal, a group voltage ground terminal, and one or more processing units, each processing unit having a voltage input terminal and a voltage ground terminal;
wherein:
the plurality of processing unit groups includes a bottom-level processing unit group and a top-level processing unit group;
the group voltage ground terminal of the bottom-level processing unit group is connected to a ground pin of the multi-core processing integrated circuit chip;
for each processing unit group other than the bottom-level processing unit group, the group voltage ground terminal of the processing unit group is connected to the group voltage input terminal of a previous-level processing unit group within the plurality of processing unit groups; and
the group voltage input terminal of the top-level processing unit group is connected to a voltage power input pin of the multi-core processing integrated circuit chip.

2. The multi-core processing integrated circuit chip according to claim 1, wherein:
a voltage drop between the group voltage input terminal and the group voltage ground terminal is identical for each of the plurality of processing unit groups.

3. The multi-core processing integrated circuit chip according to claim 2, wherein:
the processing units within the plurality of processing unit groups are all identical to each other; and
each processing unit group includes a same number of processing units.

4. The multi-core processing integrated circuit chip according to claim 1, wherein:
for at least one of the plurality of processing unit groups, the processing unit group includes a plurality of processing units.

5. The multi-core processing integrated circuit chip according to claim 4, wherein:
for the plurality of processing units within the processing unit group, the voltage input terminals of the processing units are connected together to form the group voltage input terminal of the processing unit group, and the voltage ground terminals of the processing units are connected together to form the group voltage ground terminal of the processing unit group.

6. The multi-core processing integrated circuit chip according to claim 1, further comprising:
a plurality of deep n-wells corresponding to the plurality of processing unit groups, each processing unit group being located at the corresponding deep n-well.

7. The multi-core processing integrated circuit chip according to claim 6, wherein a p-well is configured within each deep n-well to form a plurality of NMOS transistors.

8. The multi-core processing integrated circuit chip according to claim 7, wherein a second n-well is configured within each p-well to form a plurality of PMOS transistors.

9. The multi-core processing integrated circuit chip according to claim 1, wherein a number of the plurality of processing unit groups is no less than 3.

10. The multi-core processing integrated circuit chip according to claim 1, wherein the multi-core processing integrated circuit chip is configured to perform calculations in a cryptocurrency mining process.

11. A circuit board comprising a multi-core processing integrated circuit chip, the multi-core processing integrated circuit chip including:
a plurality of processing unit groups, each processing unit group including a group voltage input terminal, a group voltage ground terminal, and one or more processing units, each processing unit having a voltage input terminal and a voltage ground terminal;
wherein:
the plurality of processing unit groups includes a bottom-level processing unit group and a top-level processing unit group;
the group voltage ground terminal of the bottom-level processing unit group is connected to a ground pin of the multi-core processing integrated circuit chip;
for each processing unit group other than the bottom-level processing unit group, the group voltage ground terminal of the processing unit group is connected to the group voltage input terminal of a previous-level processing unit group within the plurality of processing unit groups; and
the group voltage input terminal of the top-level processing unit group is connected to a voltage power input pin of the multi-core processing integrated circuit chip.

12. The circuit board according to claim 11, wherein:
a voltage drop between the group voltage input terminal and the group voltage ground terminal is identical for each of the plurality of processing unit groups.

13. The circuit board according to claim 11, wherein:
the processing units within the plurality of processing unit groups are all identical to each other; and
each processing unit group includes a same number of processing units.

14. The circuit board according to claim 11, wherein:
for at least one of the plurality of processing unit groups, the processing unit group includes a plurality of processing units.

15. The circuit board according to claim 14, wherein:
for the plurality of processing units within the processing unit group, the voltage input terminals of the processing units are connected together to form the group voltage input terminal of the processing unit group, and the voltage ground terminals of the processing units are connected together to form the group voltage ground terminal of the processing unit group.

16. The circuit board according to claim 11, wherein the multi-core processing integrated circuit chip further includes:
a plurality of deep n-wells corresponding to the plurality of processing unit groups, each processing unit group being located at the corresponding deep n-well.

17. The circuit board according to claim 16, wherein a p-well is configured within each deep n-well to form a plurality of NMOS transistors.

18. The circuit board according to claim 17, wherein a second n-well is configured within each p-well to form a plurality of PMOS transistors.

19. The circuit board according to claim 11, wherein a number of the plurality of processing unit groups is no less than 3.

20. The circuit board according to claim 11, wherein the circuit board is configured to perform calculations in a cryptocurrency mining process.
